(19) United States
(12) Patent Application Publication
(10) Pub. No.: US 2005/0082345 A1
(43) Pub. Date: Apr. 21, 2005

(54) Device for production of a tube

(76) Inventors: Franz Nicolai, Mulheim (DE); Bernhard Heimann, Moers (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/494,413

(22) PCT Filed: Oct. 18, 2002
(86) PCT No.: PCT/EP02/11665

(30) Foreign Application Priority Data
Oct. 27, 2001 (DE) 101 53 144.3

(51) Int. Cl. B23K 31/02

(52) U.S. Cl. 228/151

(57) ABSTRACT

The invention relates to a device (1) for production of a tube (2) with a polygonal, preferably rectangular cross-section, comprising a tube welding unit (3), in which the tube (2) is formed from a sheet metal strip and welded at the resulting jointing position and a rolling unit (4), connected to the tube welding unit (3) in the transport direction (R) of the tube (2), which essentially rolls the tube (2) into the desired polygonal cross-sectional contour. According to the invention, right-angled tubes may be produced with the optimal geometry, whereby a camber rolling unit (5) is arranged in series with the rolling unit (4) in the transport direction (R) of the tube (2), by means of which at least two opposing tube sides (6, 7) may be rolled with a pair of crowned convex rollers (8, 9).

The invention relates to a device [apparatus] for producing a tube having a polygonal shaped cross section, preferably a rectangular cross section, which has a tube welding unit in which the tube is formed from a flat metal strip and the flat metal strip is welded at the respective seaming location, as well as a rolling unit following the tube welding unit in the feed direction of the tube which rolls the tube to substantially the desired polygonal shaped contour in cross section.

Apparatuses of this type for producing a longitudinally seamed tube are known. The German Published Application DE-AS 12 89 814, describes how a tube is formed from a metal strip which is fed to a tube welding device. For finishing the tube, the tubular shaped metal strip is welded at the respective seaming location. In German Open Application DE-OS 19 23 241 and in German Patent DE 32 12 365 C2 the structural details as to the configurations of the rollers required for rolling the tube following welding as well as for the control of the welding beam are given.

From the welding, the yet circularly shaped tube, in cross section, can be shaped in a subsequent rolling process into a tube with a rectangular cross section. For that purpose, correspondingly shaped roll pairs act upon the tube; as a rule, the roll pairs are disposed one behind the other in the feed direction of the tube and a sizing mill frame is provided downstream of them. The goal is to thereby so form the tube that it ideally assumes the desired contour, for example the rectangular shape.

So that the welded tube, which develops as a result of the reshaping and welding process significantly stress will be straight along its longitudinal axis, a subsequent straightening process is also required in which the straightening of the tube is brought about by “straight bending”.

Especially in the production of rectangular tubes, it has been found to be a problem that the tube material, because of its internal stresses has the tendency to bulge outwardly so that the desire rectangular contour may not develop. Rather, the sides of the rectangle and especially the longer sides are at least minimally bulged convexly outwardly which is a significant shape deviation by comparison with the desire contour.

It is the object of the invention to so improve an apparatus of the type described at the outset that the described drawbacks are eliminated.

The attainment of this object is achieved in accordance with the invention in that the rolling unit in the direction of advance of the tube has a convex [camber] rolling unit located downstream of it with at least one pair of crowned convex rolls acting upon at least two opposite tube sides.

To the extent that the invention counteracts the tendency of the tube sides to bulge outwardly, the polygonal tube, especially the rectangular tube, can be considered to be sized or calibrated with the convex barrel shaped rolls. The target of this approach is to roll the tube sides with such concavities that the concavities themselves counteract the tendency in the tube for outward bulging of the tube sides so that overall a tube with an ideal polygonal cross section and especially a rectangular cross section will result. In an advantageous manner, the finished polygonal or rectangular tube has a precise contour which is desired; undesired outwardly bulging sides are no longer present. Preferably, the invention is so carried out that the rolling unit, in the direction of advance of the tube has a straightening unit located downstream thereof and with which the welded tube is precisely straightened in its longitudinal direction in a manner known per se.

In that case, the barrel shaped roller unit, considered in the direction of advance of the tube, can be arranged in the region of the straightening unit. Alternatively, it is also possible to locate this unit between the rolling unit and the straightening unit.

In accordance with a further especially preferred feature, it is provided that the barrel shaped roller unit have means enabling it to be displaced in a direction traverse to the longitudinal direction of the tube so that it will exert no force or only minimal force on the tube which can tend to deflect the tube transversely to its longitudinal direction. The basis for this configuration is that the precision and efficiency of the straightening unit is enhanced when apart from the straightening forces, additional forces act upon the tube which is to be expected from the convex roller process. So that this process does not disturb the straightening process, the barrel roll or convex roll unit is arranged to “float” so that the barrel shaped rolls can follow tube deflections with respect to the straightening of the rolls without applying any additional loading tending to deflect the tube.

Preferably, the means for guiding the convex roll unit comprises at least one movement unit with which the convex roll unit can be moved traversely to the longitudinal direction of the tube. Especially preferred is an arrangement where this means includes a control circuit comprised of at least one sensor, a controller and at least one movement unit.

The movement unit can be an electrical actuating element [effector], and especially one which has an electric motor and a transmission. The translation can include a threaded spindle for linear movement of the rolls. Alternatively, the movement unit can also include a hydraulic actuating element, especially a piston and cylinder system. To optimize the rolling results of the convex roll process, adjusting means can be provided with which the radial spacing of the convex or barrel shaped rolls can be adjusted.

Advantageously, the means for dispensing the barrel shaped roll unit shifts the rolls thereof relative to a barrel shaped roll frame or roll stand which is fixed in location. To improve the production of a rectangular tube it is finally provided according to a further feature that the barrel shaped roll unit have at least two roll pairs whose axes are rotated relative to one another at right angles for rolling a rectangular tube.

In the drawing, examples of the invention are shown. The drawing shows:

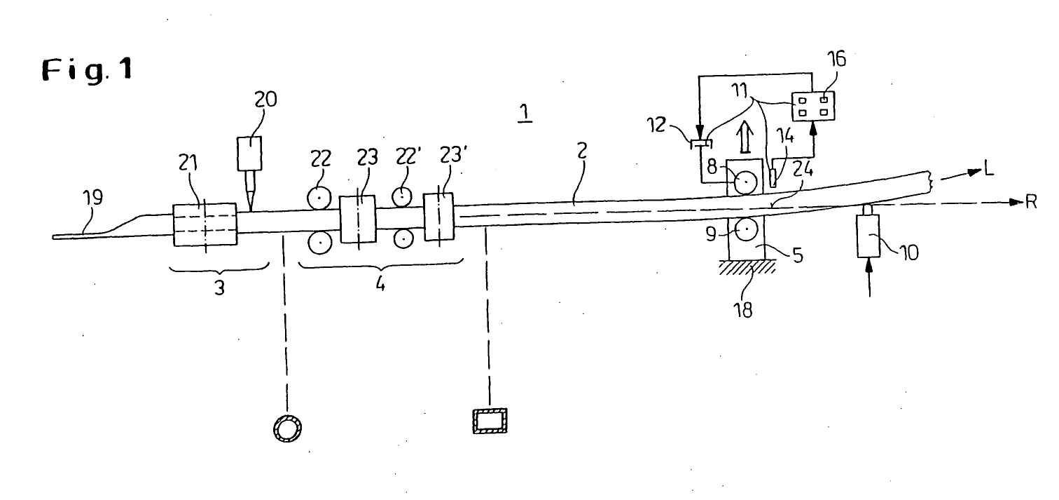

FIG. 1 a schematic view of the configuration of an apparatus for producing a rectangular tube.

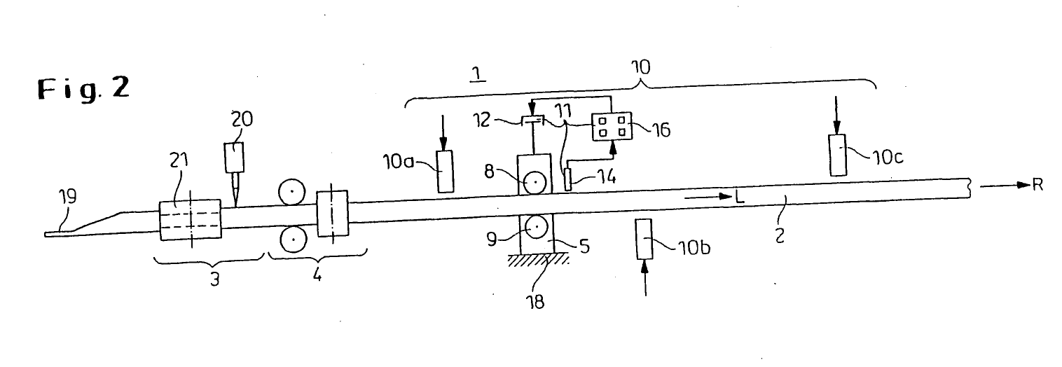

FIG. 2 a slightly modified configuration of the apparatus according to FIG. 1.

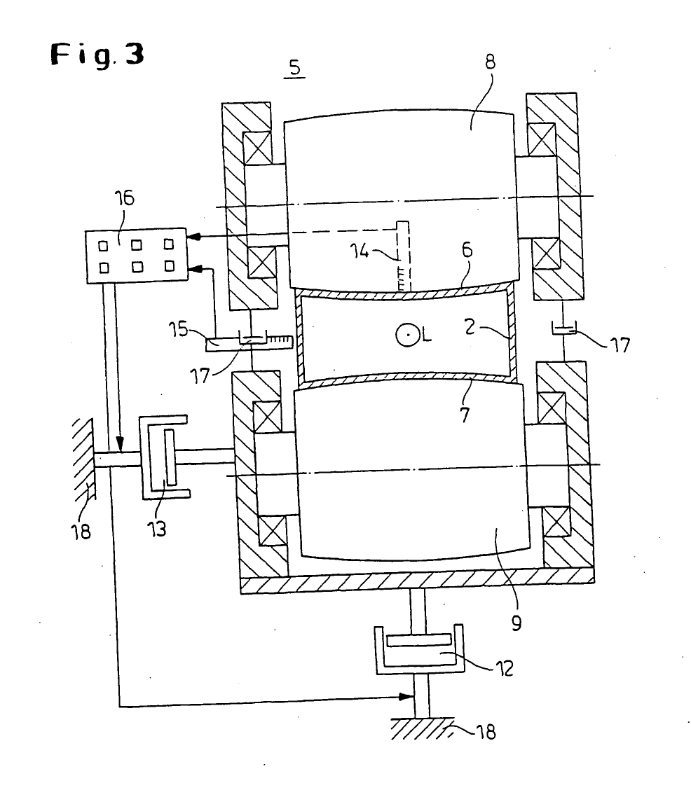

FIG. 3 a section through the barrel shaped roll unit as seen in the direction of advance of the tube and

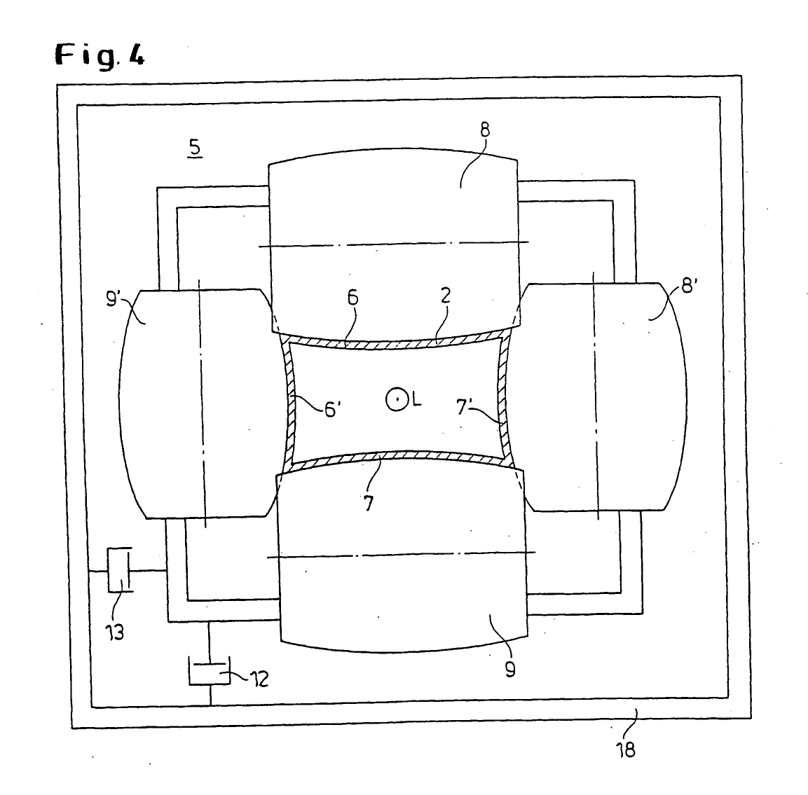

FIG. 4 an alternative configuration to FIG. 3.

In FIG. 1 the configuration of the apparatus 1 has been shown diagrammatically for the fabrication of a rectangular tube 2. The apparatus 1 is traversed from the left in the travel direction R by a flat metal strip 19. The latter is bent into a circular cross section tube in a known manner not illustrated in greater detail, and which is welded in the tube welding unit 3. That means that the metal strip which is bent into a tube is welded at the indicated welding location by a welding device 20 which has only been illustrated very schematically. During the welding process, the tube 2 is guided through the rolls 21.

At the end of the tube welding unit 3, there appears the finished circular cross section tube 2 as has been indicated diagrammatically in FIG. 1. This tube 2 is then to be reshaped into a rectangular tube. For this purpose, the rolling unit 4 is provided and is comprised of a plurality—in FIG. 1, two-sizing roll units, which are arranged one after the other in the travel direction R. Each two cooperating sizing roll pairs 22, 23, 22′, 23′ produce the desired rectangular profile as the tube reaches the end of the roll unit 4 as has also been schematically indicated in FIG. 1. In the embodiment illustrated, this is a consequence of the four roll pairs 22, 23, 22′, 23′ which are respectfully rotated through 90° with respect to one another.

As a consequence of the stresses which arise in the welding process and the preforming process in the tube 2, the latter is not initially straight along the longitudinal direction L. As a consequence, a straightening process follows in which the tube is straightened. In FIG. 1, this has been shown only highly diagrammatically. As indicated: the straightening unit 10 comprises primarily an element which can exert a force upon the tube which is largely perpendicular to the longitudinal axis L of the tube 2. As can be seen from FIG. 1, the tube 2 is thereby deflected perpendicularly to its travel direction R. Since the tube 2 is held by the roll pairs 22 through 23′ (considered with respect to the travel direction R) of the sizing frame, upon the deflection of the tube 2 by the straightening unit 10 induces a pending deformation in the tube 2 which counteracts the bending already contained in the tube.

The net result is that the tube is “bent straight”. The straightening process is carried out in two axes which are perpendicular to the longitudinal direction L of the tube 2 (in FIG. 1 only the bending about 1 axis has been illustrated). Furthermore, the straightening period is effected automatically and no more detailed description is thus included in FIG. 1. The straightening processing corresponds to the general state of the art.

In FIG. 2 it is schematically shown that the straightening unit 10 can also be comprised of a multiplicity of pressure elements 10a, 10b, 10c which exert forces perpendicular to the ideal longitudinal axis L upon the tube 2. The forces exerted by the pressure elements 10a, 10b, 10c are schematically indicated by arrows. Again, the bending has been illustrated about only one axis; exactly in the same manner the tube 2 can also be bent about at axis perpendicular to the first mentioned axis and therefore also straightened in this axis.

To counteract the tendency of the rectangular tube to bulge outwardly at the tube sides 6 and 7 (see FIG. 3), a barrel shaped roll unit 5 is provided.

This roll unit is a roll unit which, according to FIG. 1 is arranged between the roll unit 4 and the straightening unit 10. According to FIG. 2, however, the barrel shaped roll unit 5 can also be disposed proximal to the straightening unit 10.

The barrel shaped roll unit 5 has two barrel shaped rolls 8 and 9, each of which has a crowned convex shape. In traversing the barrel shaped roll unit 5, the tube sides 6 and 7 are rolled into concave configurations. The crowning of the barrel shaped rolls 8, 9 is so selected, empirically or as a result of calculation, such that the concavity induced by the rolls 8, 9 in the tube 2 is sufficiently that the compensate for the outward bulging of the tube sides 6, 7. Overall, this gives a precise straight contour of the tube sides 6 and 7 as is desired.

To prevent the straightening process by means of the straightening unit 10 from being effected by the barrel roll process and the forces which are applied thereby, the barrel shaped rolls 8, 9 are mounted to “float” on the longitudinal axis L of the tube. As a result, these rolls 8 and 9 apply no net forces perpendicular to the longitudinal axis L of the tube 2.

For this purpose, means 11 are provided for guiding the barrel shaped roll unit 5 perpendicularly to the longitudinal axis L of the tube 2. Such means can include a sensor 14 for detecting the actual (vertical) deflection of the tube 2 from the ideal line 24 (see FIG. 1) as well as a movement unit 12 for vertically displacing the barrel shaped rolls 8, 9. Sensor 14 and movement unit 12 are connected together via a control 16. Should the sensor 14 detect a deflection of the tube 2 from the ideal line 24, at via the control will cause a vertical movement of the barrel shaped rolls 8, 9, relative to its stationary barrel roll frame or stand 18 so that the rolls 8, 9 cannot transmit forces perpendicular to the longitudinal axis L to the tube 2. The straightening process thus operates efficiently and without falsification.

As is to be seen from FIG. 3, the movement of the barrel shaped rolls 8, 9 is effected in two axes:

Not only is a sensor 14 provided for detecting the vertical deflection of the tube 2 but there is also a sensor 15 for detecting the horizontal deflection. The control 16 regulates two movements 12 and 13 based upon the values detected by the sensors 14 and 15 so that the barrel shaped rolls 8, 9 are shifted both vertically and horizontally based upon such deflections.

The forces applied by the barrel shaped rolls 8, 9 are determined by the setting of an adjusting means 17 (see FIG. 3) which positions the two rolls 8 and 9 radially relative to one another.

Basically the longer tube sides have the greater tendency in the production of rectangular tubes to bulge outwardly. Nevertheless the shorter sides of the tube also can bulge outwardly.

In the embodiment of FIG. 4, it can be seen that a barrel shaped rolling of the rectangular tube can also be effected on all four sides 6, 6′, 7, 7′ of the tube 2.

The tube 2 in the illustrated case is thus contacted by a total of four barrel shaped rolls 8, 9 and 8′, 9′; all tube sides 6, 7 and 6′, 7′ are rolled with a concave curvature. It has been shown further schematically that the barrel shaped rolls 8, 9, 8′, 9′ are adjusted relatively to the stationary barrel roll frame or barrel roll stand 18 in accordance with the actual tube deflection.

### Reference Character List

1 Device for producing a tube
2 Device for producing a tube
3 Tube Welding Unit
4 Roll Unit
5 Barrel Roll Unit
6 Tube Side
7 Tube Side
6′ Tube Side
7′ Tube Side
8 Barrel Roll (Upper Roll)
9 Barrel Roll (Lower Roll)
10 Straightening Unit
10a Pressure Element
10b Pressure Element
10c Pressure Element
11 Means for Displacing the Barrel Roll Unit 5
12 Vertical Movement Unit
13 Horizontal Movement Unit
14 Vertical Sensor
15 Horizontal Sensor
16 Control
17 Adjusting Means
18 Barrel Roll Frame or Stand
19 Metal Strip
20 Welding Device
21 Rolls
22 Sizing Rolls
23 Sizing Rolls
22′ Sizing Rolls
23′ Sizing Rolls
24 Ideal Line
R Said Direction
L Longitudinal Direction of the Tube 2

1. An apparatus (1) for producing a polygonal cross section, preferably rectangular cross section, tube (2) which has a tube welding unit (3) in which a flat metal strip is shaped into the tube (2) and welds the tube at a given welding location, as well as a roll unit (4) following the tube welding unit (3) in the direction of advance (R) of the tube (2) in which the tube (2) is rolled to substantially the desired polygonal cross section contour,
characterized in that
the roll unit (4) is followed by a barrel roll unit (5) in the direction of advance (R) of the tube (2) which has at least two crowned convex rolls (8,9) engaging at least two opposite tube sides (6,7) of the tube (2).

2. The apparatus according to claim 1 characterized in that the roll unit (4) is followed in the direction of advance (R) of the tube (2) by a straightening unit (10) which straightens the welded tube (2) in its longitudinal direction (L).

3. The apparatus according to claim 2 characterized in that the barrel roll unit (5) considered in the direction of advance (R) of the tube (2) is arranged in the region of the straightening unit (10).

4. The apparatus according to claim 2 characterized in that the barrel roll unit (5) is arranged between the roll unit (4) and the straightening unit (10).

5. The apparatus according to claim 1 characterized in that the barrel roll unit (5) has means (11) which enables its displacement in a direction transverse to the longitudinal direction (L) of the tube (2) such that it does not exert any net force or only a minimum net force upon the tube (2).

6. The apparatus according to claim 5 characterized in that the means (11) enabling displacement of the barrel roll unit (5) has at least one movement unit (12, 13) effecting movement of the barrel roll unit (5) traverse to the longitudinal direction (L) of the tube (2).

7. The apparatus according to claim 5 characterized in that the means (11) ha a control circuit comprised of at least one sensor (14,15) a control (16) and at least one movement unit (12,13).

8. The apparatus according to claim 6 characterized in that the movement unit (12, 13) is an electrical effector.

9. The apparatus according to claim 8 characterized in that the movement unit (12, 13) has an electrical motor and a translation.

10. The apparatus according to claim 9 characterized in that the transmission has a threaded spindle for linear movement for the rolls 8, 9.

11. The apparatus according to claim 6, characterized in that the movement unit (12, 13) is a hydraulic effector.

12. The apparatus according to claim 11 characterized in that the effector is a piston-cylinder system.

13. The apparatus according to claim 1 characterized by an adjusting means (17) whereby the radial spacing of the rolls (8, 9) can be adjusted.

14. The apparatus according to claim 5 characterized in that the means (11) for enabling movement of the barrel roll unit (5) and the rolls (8,9) relative to a fixed barrel roll frame or barrel roll stand (18).

15. The apparatus according to claim 1 characterized in that the barrel roll unit (5) has at least two roll pairs (8,9,8′,9′) whose axes are rotated relative to one another through 90° for the rolling of a rectangular tube (2).
